(19) United States
(12) Patent Application Publication
(10) Pub. No.: US 2024/0051780 A1
(43) Pub. Date: Feb. 15, 2024

(54) SHEET CONVEYANCE DEVICE, IMAGE READING DEVICE, AND IMAGE FORMING DEVICE

(71) Applicant: KYOCERA Document Solutions Inc., Osaka-shi, Osaka (JP)

(72) Inventor: Yoji ISOGAI, Osaka (JP)

(21) Appl. No.: 18/547,124

(22) PCT Filed: Feb. 16, 2022
(86) PCT No.: PCT/JP2022/006082

§ 371 Date: Aug. 18, 2023

(30) Foreign Application Priority Data
Feb. 24, 2021 (JP) 2021-027175

(51) Int. Cl. B65H 29/24; B65H 43/02

(52) U.S. Cl. CPC B65H 29/246; B65H 43/02

(57) ABSTRACT

The present invention aims at avoiding a stacking failure of sheets on a discharge tray. A conveyance mechanism (51) conveys a sheet along a conveyance path (500), and further discharges the sheet from a discharge port (500a) of the conveyance path (500). A discharge tray (56) is disposed below the discharge port (500a) on a downstream side of a discharge direction of the sheet, and receives the sheet discharged from the discharge port (500a). A blower (58) is disposed above the discharge tray (56) or above the discharge port (500a), and blows air downwardly onto the sheet on the discharge tray (56).

### TECHNICAL FIELD

The present invention relates to a sheet conveyance device, an image reading device, and an image forming device with which a stacking failure of sheets on a discharge tray can be avoided.

### BACKGROUND

An image reading device or an image forming device includes a sheet conveyance device. The sheet conveyance device conveys a sheet along a conveyance path and further discharges the sheet from the conveyance path onto a discharge tray. The sheet in the image reading device is a document sheet formed with an image, and the sheet in the image forming device is a paper sheet as an image forming medium.

In addition, the image forming device is known to include a blower which cools the sheet that is conveyed by the sheet conveyance device after passing through a fixing device (see, for example, Patent Literature 1).

### CITATION LIST

### Patent Literature

Patent Literature 1: Japanese Patent Application Publication No. 2011-197108

### SUMMARY

### Technical Problem

Incidentally, the sheet conveyed by the sheet conveyance device might get caught on a peripheral member while being dropped from the discharge port onto the discharge tray. In this case, a stacking failure of the sheet occurs on the discharge tray.

When a stacking failure of the sheet occurs, inconveniences including the sheet falling out of the discharge tray, a sheet detection portion provided in the discharge tray being unable to detect the sheet, and the like may be caused.

The present invention aims at providing a sheet conveyance device with which a stacking failure of sheets on a discharge tray can be avoided, and an image reading device or image forming device including the sheet conveyance device.

### Solution to Problem

A sheet conveyance device according to one aspect of the present invention includes a conveyance mechanism, a discharge tray, and a blower. The conveyance mechanism conveys a sheet along a conveyance path and further discharges the sheet from a discharge port of the conveyance path. The discharge tray is disposed below the discharge port on a downstream side of a discharge direction of the sheet, and receives the sheet discharged from the discharge port. The blower is disposed above the discharge tray or above the discharge port and blows air downwardly onto the sheet on the discharge tray.

An image reading device according to another aspect of the present invention includes the sheet conveyance device and a reading portion which reads an image from a sheet conveyed by the sheet conveyance device and outputs data of the read image.

An image forming device according to another aspect of the present invention includes the sheet conveyance device and a printing portion which forms an image on a sheet conveyed by the sheet conveyance device.

### Advantageous Effects of Invention

According to the present invention, it becomes possible to provide a sheet conveyance device with which a stacking failure of sheets on a discharge tray can be avoided, and an image reading device or image forming device including the sheet conveyance device.

### BRIEF DESCRIPTION OF THE DRAWINGS

FIG. 1 is a configuration diagram of an image processing apparatus including a document sheet conveyance device which is an example of a sheet conveyance device according to a first embodiment.

FIG. 2 is a block diagram showing a configuration of a control device in the image processing apparatus.

FIG. 3 is a configuration diagram showing a periphery of a document sheet discharge tray in the document sheet conveyance device according to the first embodiment.

FIG. 4 is a diagram showing a state where a document sheet is in midst of being discharged by a discharge roller pair in the document sheet conveyance device according to the first embodiment.

FIG. 5 is a diagram showing a state where appropriate discharge of a document sheet onto the document sheet discharge tray is facilitated in the document sheet conveyance device according to the first embodiment.

FIG. 6 is a configuration diagram of an image processing apparatus including a paper sheet conveyance device which is an example of a sheet conveyance device according to a second embodiment.

FIG. 7 is a diagram showing a state where a document sheet is caught on a peripheral member of a document sheet discharge tray in a conventional document sheet conveyance device.

FIG. 8 is a diagram showing a state where a curved document sheet is discharged onto the document sheet discharge tray in the conventional document sheet conveyance device.

### DETAILED DESCRIPTION

Embodiments of the present invention will be described below with reference to the accompanying drawings. It is noted that the following embodiments are examples of embodying the present invention and do not limit the technical scope of the present invention.

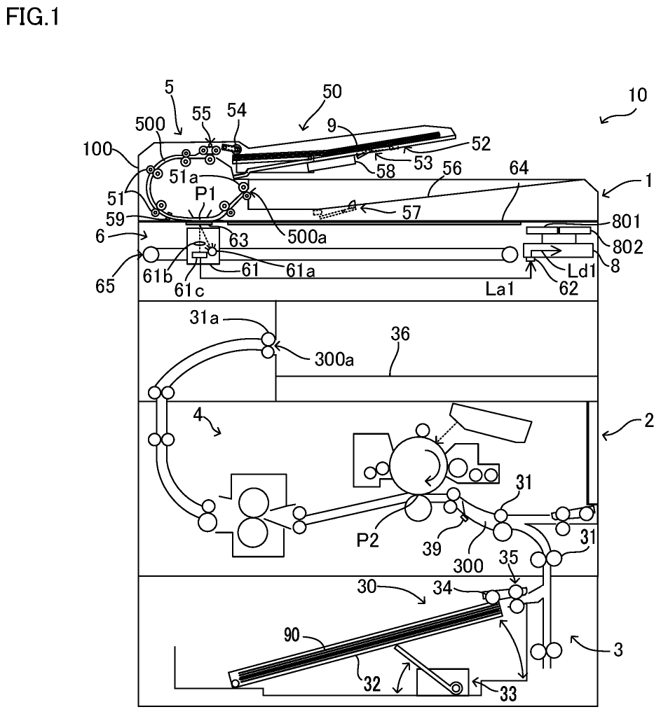

A document sheet conveyance device 5 as an example of a sheet conveyance device according to a first embodiment of the present invention is included in an image processing apparatus 10 (see FIG. 1).

[Configuration of Image Processing Apparatus 10]

As shown in FIG. 1, the image processing apparatus 10 includes an image reading device 1 which reads an image from a document sheet 9 and an image forming device 2 which forms an image on a paper sheet 90. The document sheet 9 and the paper sheet 90 are each an example of a sheet.

The image processing apparatus 10 further includes an operation device 801, a display device 802, and a control device 8. The operation device 801, the display device 802, and the control device 8 are a part of the image reading device 1, and are also a part of the image forming device 2.

The operation device 801 is a device that accepts user operations and includes, for example, operation buttons and a touch panel. The display device 802 is a device that displays information and includes, for example, a panel display device such as a liquid crystal display unit.

The control device 8 executes various types of data processing, control of the image reading device 1, and control of the image forming device 2.

The image reading device 1 includes a document sheet conveyance device 5 and a reading portion 6. The document sheet conveyance device 5 includes a document sheet supplying device 50, a plurality of conveying roller pairs 51, and a document sheet discharge tray 56.

The document sheet supplying device 50 conveys document sheets 9 stacked in a document sheet supplying tray 52 one by one to a document sheet conveyance path 500. The document sheet 9 is a sheet to be an image reading target.

The document sheet supplying device 50 includes the document sheet supplying tray 52, a document sheet supplying roller 54, and a document sheet sorting portion 55. The document sheet supplying tray 52 is a portion where the document sheets 9 are stacked.

The document sheet supplying roller 54 is biased toward an upper surface of a high-order document sheet which is an uppermost sheet out of the document sheets 9 stacked in the document sheet supplying tray 52. The document sheet supplying roller 54 is rotationally driven so as to feed the high-order document sheet from the document sheet supplying tray 52.

In a case where a plurality of document sheets 9 are fed by the document sheet supplying roller 54, the document sheet sorting portion 55 feeds only the high-order document sheet to the document sheet conveyance path 500. The document sheet sorting portion 55 causes the document sheet 9 below the high-order document sheet to be retained.

The plurality of conveying roller pairs 51 convey the document sheet 9 supplied from the document sheet supplying device 50 along the document sheet conveyance path 500, and further discharge the document sheet 9 from a discharge port 500a of the document sheet conveyance path 500 onto the document sheet discharge tray 56. The plurality of conveying roller pairs 51 are an example of a conveyance mechanism.

One pair out of the plurality of conveying roller pairs 51 is a discharge roller pair 51a which discharges the document sheet 9 from the discharge port 500a onto the document sheet discharge tray 56. The document sheet conveyance path 500 is formed along a path that passes through a reading position P1.

The document sheet discharge tray 56 is disposed below the discharge port 500a of the document sheet conveyance path 500 on a downstream side of a discharge direction of the document sheet 9. The document sheet discharge tray 56 receives the document sheet 9 discharged from the discharge port 500a.

As shown in FIG. 1 and FIG. 3, the document sheet conveyance device 5 further includes a document sheet detection portion 57 provided in the document sheet discharge tray 56. The document sheet detection portion 57 includes a rocking member 571 and a detection sensor 572 (see FIG. 3).

The rocking member 571 is supported by a supporting shaft 571a in a manner that it is capable of rocking. The rocking member 571 includes a contact portion 571b protruding upwardly from an upper surface of the document sheet discharge tray 56 and a to-be-detected portion 571c that does not interfere with the document sheet 9.

When applied with a weight of the document sheet 9, the contact portion 571b is displaced from a predetermined protrusion position to a downward lowering position. Along with the displacement of the contact portion 571b from the protrusion position to the lowering position, the to-be-detected portion 571c is displaced from a predetermined evacuation position to a detection position.

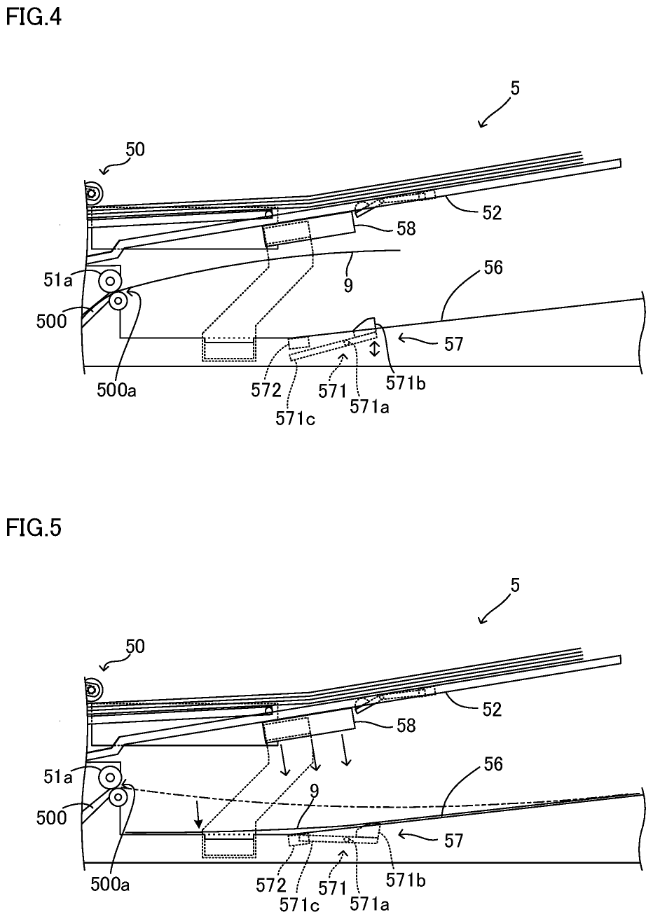

FIG. 3 and FIG. 4 each show a state where the contact portion 571b is positioned at the protrusion position and the to-be-detected portion 571c is positioned at the evacuation position. FIG. 5 shows a state where the contact portion 571b is positioned at the lowering position and the to-be-detected portion 571c is positioned at the detection position.

The detection sensor 572 detects the to-be-detected portion 571c at the detection position corresponding to the lowering position of the contact portion 571b. Thus, the detection sensor 572 detects that the document sheet 9 is present on the document sheet discharge tray 56.

For example, a transmission-type photosensor or a reflection-type photosensor is adopted as the detection sensor 572. Alternatively, a contact-type limit switch may be adopted as the detection sensor 572.

It is noted that the document sheet detection portion 57 is an example of a sheet detection portion. The rocking member 571 is an example of a displacement portion which is displaced by a weight of a sheet. In addition, the detection sensor 572 is an example of a sensor which detects a displacement of the displacement portion.

The reading portion 6 executes image reading processing on the document sheet 9 conveyed along the document sheet conveyance path 500. The image reading processing is processing of reading an image from the document sheet 9 and outputting data of the read image. The reading portion 6 includes an image sensor unit 61, an AFE (Analog Front End) 62, and contact glass 63.

The image sensor unit 61 includes a light-emitting portion 61a, a lens 61b, and an image sensor 61c.

The light-emitting portion 61a irradiates light onto the document sheet 9. The lens 61b guides light reflected by the document sheet 9 to the image sensor 61c. The image sensor 61c is a line sensor that detects an intensity of the light reflected by the document sheet 9, and outputs a detection signal as an image signal La1.

The AFE 62 converts the image signal La1 into read image data Ld1 which is digital image data. In the example shown in FIG. 1, the image sensor unit 61 is a CIS (Contact Image Sensor) in which the light-emitting portion 61a, the lens 61b, and the CMOS (Complementary Metal Oxide Semiconductor)-type image sensor 61c are integrated.

The contact glass 63 is a transparent member disposed opposite to the reading position P1 on the document sheet conveyance path 500. Under a situation where the image sensor unit 61 is present at a position opposite to the contact glass 63, the light-emitting portion 61a irradiates light onto the document sheet 9 that passes through the reading position P1 via the contact glass 63.

In the present embodiment, the reading portion 6 further includes platen glass 64 and a unit movement mechanism 65. The platen glass 64 is disposed next to the contact glass 63. The platen glass 64 is a transparent document sheet table on which the document sheet 9 is to be placed.

The unit movement mechanism 65 causes the image sensor unit 61 to move within a range between a position opposing the contact glass 63 and a position opposing the platen glass 64.

When the document sheet 9 is conveyed by the document sheet conveyance device 5, the unit movement mechanism 65 retains the image sensor unit 61 at the position opposing the contact glass 63. Thus, while the document sheet 9 that passes through the reading position P1 is scanned by the light of the light-emitting portion 61a, the image sensor 61c reads an image of the document sheet 9.

In other words, when the document sheet conveyance device 5 is operating, the reading portion 6 reads an image from the document sheet 9 supplied by the document sheet conveyance device 5, and outputs read image data Ld1.

On the other hand, when the document sheet 9 is placed on the platen glass 64, the unit movement mechanism 65 causes the image sensor unit 61 to move along the platen glass 64. Thus, while the document sheet 9 on the platen glass 64 is scanned by the light of the light-emitting portion 61a, the image sensor 61c reads an image of the document sheet 9.

In other words, when the document sheet conveyance device 5 is not operating, the reading portion 6 executes the image reading processing on the document sheet 9 placed on the platen glass 64.

It is noted that the image sensor 61c may alternatively be a CCD (Charge Coupled Device)-type sensor. In this case, the unit movement mechanism 65 causes the light-emitting portion 61a and the lens 61b to move, and the CCD-type image sensor 61c is fixed at a predetermined position.

The document sheet conveyance device 5 is incorporated into a document sheet cover 100 that is supported while enabling the upper surfaces of the contact glass 63 and the platen glass 64 to open/close. The document sheet conveyance device 5 is operable when the document sheet cover 100 is in a closed state in which it covers the contact glass 63.

The image forming device 2 executes printing processing for forming an image on the paper sheet 90. For example, the image forming device 2 is capable of executing the printing processing that is based on the read image data Ld1 obtained by the image reading device 1. The paper sheet 90 is an example of the sheet.

The image forming device 2 includes a paper sheet conveyance device 3 and a printing portion 4. The paper sheet conveyance device 3 includes a paper sheet supplying device 30, a plurality of conveying roller pairs 31, and a paper sheet discharge tray 36.

The paper sheet supplying device 30 feeds the paper sheets 90 stacked in a paper sheet supplying tray 32 one by one to a paper sheet conveyance path 300. The paper sheet 90 is a sheet to be an image forming medium.

The paper sheet supplying device 30 includes the paper sheet supplying tray 32, a paper sheet supplying roller 34, and a paper sheet sorting portion 35. The paper sheet supplying tray 32 is a portion where the paper sheets 90 are stacked.

The paper sheet supplying roller 34 is biased toward an upper surface of a high-order paper sheet which is an uppermost paper sheet out of the paper sheets 90 stacked in the paper sheet supplying tray 32. The paper sheet supplying roller 34 is rotationally driven so as to feed the high-order paper sheet from the paper sheet supplying tray 32.

In a case where a plurality of paper sheets 90 are fed by the paper sheet supplying roller 34, the paper sheet sorting portion 35 feeds only the high-order paper sheet to the paper sheet conveyance path 300. The paper sheet sorting portion 35 causes the paper sheet 90 below the high-order paper sheet to be retained.

The plurality of conveying roller pairs 31 convey the paper sheet 90 supplied from the paper sheet supplying device 30 along the paper sheet conveyance path 300, and further discharge the paper sheet 90 from a discharge port 300a of the paper sheet conveyance path 300 onto the paper sheet discharge tray 36. The plurality of conveying roller pairs 31 are an example of the conveyance mechanism.

One pair out of the plurality of conveying roller pairs 31 is a discharge roller pair 31a which discharges the paper sheet 90 from the discharge port 300a onto the paper sheet discharge tray 36. The paper sheet conveyance path 300 is formed along a path that passes through an image forming position P2.

The paper sheet conveyance device 3 includes a passing paper sheet sensor 39 which detects the paper sheet 90 that passes through a predetermined registration position on the paper sheet conveyance path 300.

The paper sheet discharge tray 36 is disposed below the discharge port 300a of the paper sheet conveyance path 300 on a downstream side of a discharge direction of the paper sheet 90. The paper sheet discharge tray 36 receives the paper sheet 90 discharged from the discharge port 300a.

The printing portion 4 executes the printing processing on the paper sheet 90 conveyed by the paper sheet conveyance device 3. At this time, the printing portion 4 forms an image on the paper sheet 90 that passes through the image forming position P2.

In the example shown in FIG. 1, the printing portion 4 is a device which executes the printing processing by electrophotography. It is noted that the printing portion 4 may alternatively be a device which executes the printing processing using an inkjet system.

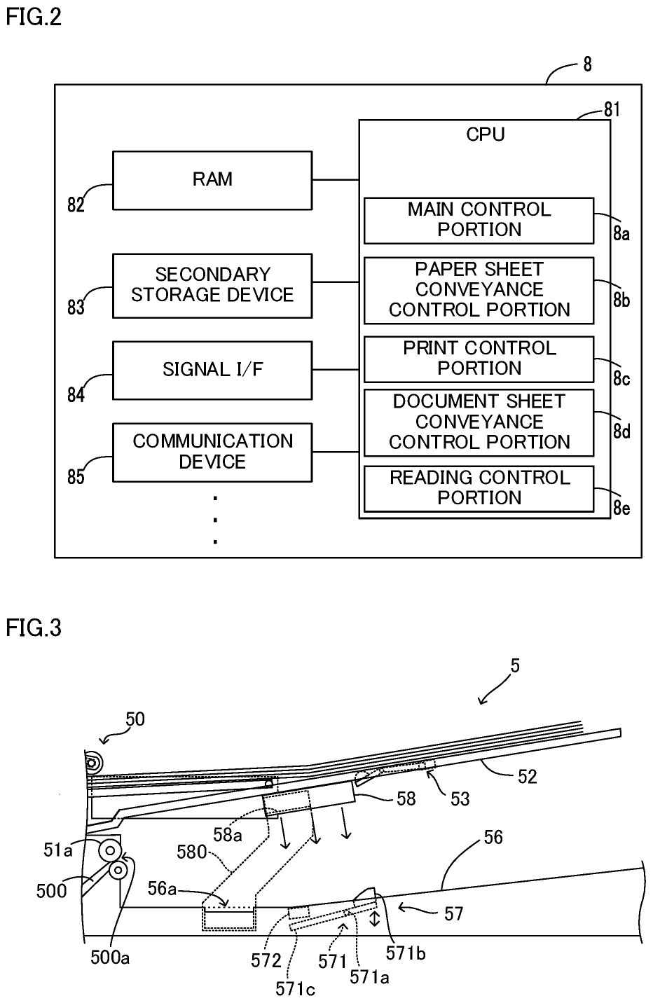

As shown in FIG. 2, the control device 8 includes a CPU (Central Processing Unit) 81 and peripheral equipment such as a RAM (Random Access Memory) 82, a secondary storage device 83, and a signal interface 84. In addition, the control device 8 also includes a communication device 85 capable of communicating with other devices.

The CPU 81 is a processor which executes computer programs to thus execute various types of data processing and control. The RAM 82 is a computer-readable volatile storage device. The RAM 82 primarily stores the computer programs to be executed by the CPU 81 and data to be output and referenced by the CPU 81 during a process of executing the various types of data processing.

The secondary storage device 83 is a computer-readable nonvolatile storage device. The secondary storage device 83 is capable of storing and updating the computer programs and various types of data. For example, one of or both of a flash memory and a hard disk drive may be adopted as the secondary storage device 83.

The signal interface 84 converts signals output by various sensors into digital data, and transmits the digital data obtained by the conversion to the CPU 81. In addition, the signal interface 84 converts control instructions output by the CPU 81 into control signals, and transmits the control signals to control target equipment.

The communication device 85 executes communication with other devices such as a host device which transmits various jobs to the image processing apparatus 10. The CPU 81 communicates with the other devices via the communication device 85.

The CPU 81 includes a plurality of processing modules that are realized by executing the computer programs. The plurality of processing modules include a main control portion 8a, a paper sheet conveyance control portion 8b, a print control portion 8c, a document sheet conveyance control portion 8d, a reading control portion 8e, and the like.

The main control portion 8a executes control for starting various types of processing in accordance with operations made to the operation device 801, control of the display device 802, and the like.

The paper sheet conveyance control portion 8b controls the paper sheet conveyance device 3 to thus control conveyance of the paper sheet 90. The paper sheet conveyance control portion 8b controls a timing to convey the paper sheet 90 to the image forming position P2 based on a detection result obtained by the passing paper sheet sensor 39.

The print control portion 8c causes the printing portion 4 to execute the printing processing in sync with the conveyance of the paper sheet 90 by the paper sheet conveyance device 3.

The document sheet conveyance control portion 8d controls the document sheet conveyance device 5 to thus control the conveyance of the document sheet 9. The reading control portion 8e controls the reading portion 6 to thus cause the reading portion 6 to execute the image reading processing.

Incidentally, the document sheet 9 conveyed by the document sheet conveyance device 5 might get caught on a peripheral member while being dropped from the discharge port 500a of the document sheet conveyance path 500 onto the document sheet discharge tray 56. In this case, a stacking failure of the document sheet 9 occurs on the document sheet discharge tray 56.

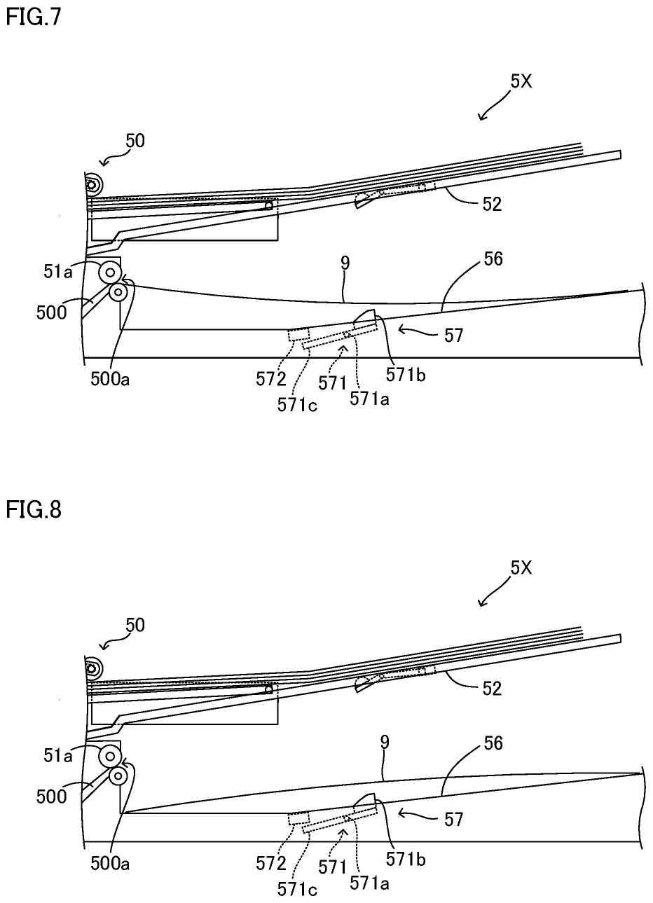

FIG. 7 shows a state where, in a conventional document sheet conveyance device 5X, the document sheet 9 is caught on a peripheral member of the document sheet discharge tray 56. Similar to the document sheet conveyance device 5, the document sheet conveyance device 5X shown in FIG. 7 includes the document sheet supplying device 50, the plurality of conveying roller pairs 51, the document sheet discharge tray 56, and the document sheet detection portion 57.

When a stacking failure of the document sheet 9 occurs, inconveniences including the document sheet 9 falling out of the document sheet discharge tray 56, the document sheet detection portion 57 provided in the document sheet discharge tray 56 being unable to detect the document sheet 9, and the like may be caused (see FIG. 7).

Moreover, as shown in FIG. 8, also when a curved document sheet 9 is discharged onto the document sheet discharge tray 56 in the conventional document sheet conveyance device 5X, an inconvenience that the document sheet detection portion 57 is unable to detect the document sheet 9 may be caused.

On the other hand, the document sheet conveyance device 5 includes a configuration for avoiding a stacking failure of the document sheet 9 on the document sheet discharge tray 56. Hereinafter, that configuration will be described.

The document sheet conveyance device 5 further includes a blower 58 (see FIG. 1 and FIG. 3). The blower 58 is disposed above the document sheet discharge tray 56. In the example shown in FIG. 1 and FIG. 3, the blower 58 is attached to a lower surface of the document sheet supplying tray 52.

In the present embodiment, the blower 58 and the contact portion 571b of the rocking member 571 are disposed so as to oppose each other. It is noted that the blower 58 may alternatively be disposed above the discharge port 500a of the document sheet conveyance path 500.

The blower 58 blows air downwardly onto the document sheet 9 on the document sheet discharge tray 56. A wind force of the blower 58 acts as a force that presses the document sheet 9 against the document sheet discharge tray 56. Thus, a stacking failure that the document sheet 9 stays caught on the peripheral member while being dropped onto the document sheet discharge tray 56 is avoided (see FIG. 5 and FIG. 7).

Further, even when the curved document sheet 9 is discharged onto the document sheet discharge tray 56, a detection failure that the document sheet 9 is not detected by the document sheet detection portion 57 is avoided owing to the action of the blower 58.

On the other hand, as shown in FIG. 4, there is a fear that, during a period in which the document sheet 9 is in midst of being discharged from the discharge port 500a of the document sheet conveyance path 500, the wind force of the blower 58 may inhibit smooth discharge of the document sheet 9.

In this regard, the document sheet conveyance control portion 8d executes, with respect to the blower 58, fluctuating air-blow control including first period control and second period control. In descriptions below, predetermined two-step outputs of the blower 58 will respectively be referred to as a reference output and a standby output. The standby output is lower than the reference output.

The first period control is control for causing the blower 58 to operate at the standby output during a first period including a period in which the document sheet 9 is in midst of being discharged from the discharge port 500a. The second period control is control for causing the blower 58 to operate at the reference output during a second period after the first period.

In the present embodiment, the document sheet conveyance device 5 includes a passing document sheet sensor 59 which detects the document sheet 9 that passes through a predetermined position on the document sheet conveyance path 500 (see FIG. 1).

The document sheet conveyance control portion 8d determines the first period based on a detection result obtained by the passing document sheet sensor 59.

For example, the document sheet conveyance control portion 8d determines that a time point at which a predetermined time has elapsed since a time point at which the passing document sheet sensor 59 has detected the document sheet 9 is a start point of the first period.

In addition, the document sheet conveyance control portion 8d determines that a time point at which a predetermined time has elapsed since a time point at which a change has been made to a state where the document sheet 9 is no longer detected by the passing document sheet sensor 59 is an end point of the first period. For example, the second period is a period from the end point of the first period to a time point at which a predetermined time has elapsed since the end point. The second period may be a period from the end point of the first period to a start point of the next first period.

FIG. 4 shows a state where the first period control is being executed, and FIG. 5 shows a state where the second period control is being executed. By executing the fluctuating air-blow control, a situation where the wind force of the blower 58 inhibits the smooth discharge of the document sheet 9 is avoided.

Further, the main control portion 8a executes discharge determination processing for determining whether the document sheet 9 is present on the document sheet discharge tray 56 based on a detection state of the document sheet detection portion 57 obtained when the blower 58 is operating at the reference output. The main control portion 8a which executes the discharge determination processing is an example of a determination portion.

It is noted that the document sheet conveyance control portion 8d may stop the blower 58 in the first period control.

In the present embodiment, the document sheet conveyance device 5 further includes a supplied document sheet detection portion 53 provided in the document sheet supplying tray 52 (see FIG. 1 and FIG. 3). The supplied document sheet detection portion 53 detects the document sheet 9 placed on the document sheet supplying tray 52.

For example, the supplied document sheet detection portion 53 has a configuration similar to that of the document sheet detection portion 57 provided in the document sheet discharge tray 56.

The document sheet conveyance control portion 8d determines that image reading processing carried out during a period from a conveyance start time point to a conveyance end time point is one image reading job. The conveyance start time point is a time point at which conveyance of the document sheet 9 is started under a situation where the document sheet 9 is being detected by the supplied document sheet detection portion 53. The conveyance end time point is a time point at which conveyance of the document sheet 9 being conveyed ends when the document sheet 9 is no longer detected by the supplied document sheet detection portion 53.

In one image reading job, one or a plurality of document sheets 9 is/are conveyed by the document sheet conveyance device 5.

Moreover, the main control portion 8a executes predetermined first failure notification processing in a case where a predetermined first failure condition is established. The main control portion 8a which executes the first failure notification processing that is based on the first failure condition is an example of a first notification portion.

The first failure condition is a condition that, when conveyance of one or a plurality of document sheets 9 corresponding to one image reading job is ended, the main control portion 8a determines that there is no document sheet 9 on the document sheet discharge tray 56.

For example, the first notification processing is processing for causing a notification which notifies that there is a possibility that a conveyance failure of the document sheet 9 may have occurred to be displayed on a display portion of the display device 802 or the host device associated with the image reading job.

In addition, the main control portion 8a executes predetermined second failure notification processing when a predetermined second failure condition is established. The main control portion 8a which executes the second failure notification processing that is based on the second failure condition is an example of a second notification portion.

The second failure condition is a condition related to a determination result on whether the document sheet 9 is present on the document sheet discharge tray 56, that is obtained by the main control portion 8a while conveyance of a plurality of document sheets 9 corresponding to one image reading job is being executed.

For example, the second failure condition is a condition that, while the conveyance of the plurality of document sheets 9 is being executed, it is consecutively determined that there is no document sheet 9 on the document sheet discharge tray 56 regarding discharge processing of a predetermined number of document sheets 9.

The second notification processing is processing for causing a notification which notifies that there is a possibility that a conveyance failure of the document sheet 9 may have occurred to be displayed on the display portion of the display device 802 or the host device associated with the image reading job.

Moreover, the document sheet conveyance control portion 8d executes pre-start air-blow control for causing the blower 58 to temporarily operate at the reference output before conveyance of one or a plurality of document sheets 9 corresponding to a new image reading job is started.

Further, when a predetermined warning condition is established, the document sheet conveyance control portion 8d executes document sheet conveyance restriction processing, and the main control portion 8a executes predetermined warning notification processing.

The warning condition is a condition related to a determination result obtained by the main control portion 8a on whether the document sheet 9 is present on the document sheet discharge tray 56. Specifically, the warning condition is a condition that, while the pre-start air-blow control is being executed, the main control portion 8a determines that the document sheet 9 is present on the document sheet discharge tray 56.

The document sheet conveyance restriction processing is processing for restricting conveyance of the document sheets 9 corresponding to a new image reading job. The document sheet conveyance control portion 8d prohibits the conveyance of the document sheets 9 corresponding to the new image reading job until a predetermined cancel condition is established.

For example, the cancel condition is a condition that the warning condition is no longer established, a condition that a predetermined cancel operation has been made to the operation device 801, or the like.

The warning processing is processing for causing a notification which notifies that an execution of a new image reading job will be restricted if the document sheet 9 left on the document sheet discharge tray 56 is not removed, to be displayed on a predetermined display portion. The main control portion 8a which executes the warning processing that is based on the warning condition is an example of a third notification portion.

The predetermined display portion is the display device 802 of the image processing apparatus 10 or display portions of the host devices respectively associated with the last image reading job and the new image reading job.

As described above, the main control portion 8a determines whether the document sheet 9 is present on the document sheet discharge tray 56 when the blower 58 is being operated at the reference output. In addition, the document sheet conveyance control portion 8d executes the various types of notification processing based on that determination result.

Therefore, a leak in the detection of the document sheet 9 on the document sheet discharge tray 56 due to the document sheet 9 being caught, a curved document sheet 9, or the like and a leak in the notification processing or the warning processing are avoided.

Moreover, in the example shown in FIG. 3, an inlet opening 56a as an air inlet is formed on the upper surface of the document sheet discharge tray 56. In this case, the document sheet conveyance device 5 includes a ventilation duct 580 which brings the inlet opening 56a formed on the upper surface of the document sheet discharge tray 56 and an air supply port 58a of the blower 58 in communication with each other.

By an action of the ventilation duct 580, the wind force of the blower 58 acts as a force that sucks the document sheet 9 from below and a force that presses the document sheet 9 from above. Thus, the output of the blower 58 is used more efficiently as a force that causes the document sheet 9 to fit in the document sheet discharge tray 56.

### Second Embodiment

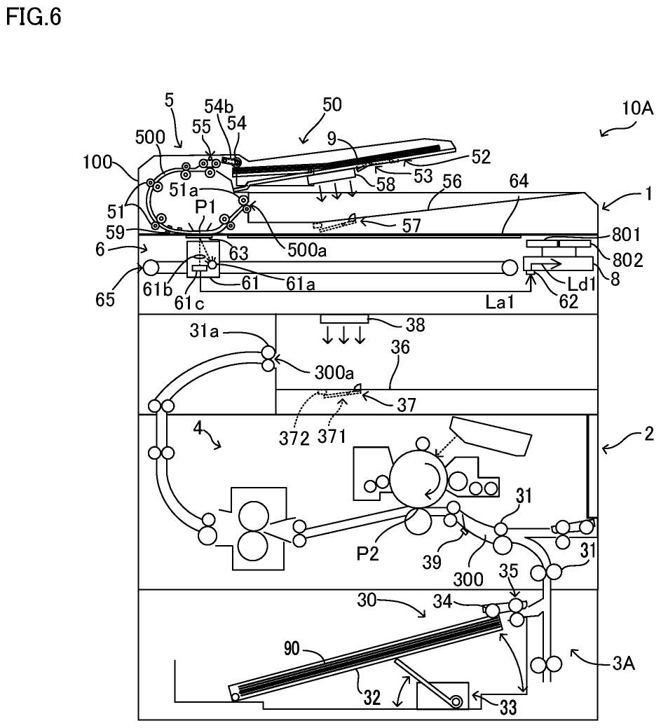

Next, a paper sheet conveyance device 3A as an example of a sheet conveyance device according to a second embodiment of the present invention and an image processing apparatus 10A including that paper sheet conveyance device 3A will be described with reference to FIG. 6.

The paper sheet conveyance device 3A of the image processing apparatus 10A has a configuration in which a paper sheet detection portion 37 and a blower 38 are added to the paper sheet conveyance device 3 of the image processing apparatus 10.

The paper sheet discharge tray 36, the paper sheet detection portion 37, and the blower 38 in the paper sheet conveyance device 3A have configurations respectively corresponding to the document sheet discharge tray 56, the document sheet detection portion 57, and the blower 58 in the document sheet conveyance device 5.

The blower 38 is disposed above the paper sheet discharge tray 36. It is noted that the blower 38 may alternatively be disposed above the discharge port 300a of the paper sheet conveyance path 300.

As shown in FIG. 6, the paper sheet detection portion 37 is provided in the paper sheet discharge tray 36. Similar to the document sheet detection portion 57, the paper sheet detection portion 37 includes a rocking member 371 and a detection sensor 372. The rocking member 371 and the detection sensor 372 respectively have configurations similar to those of the rocking member 571 and the detection sensor 572 in the document sheet detection portion 57.

In the present embodiment, the blower 38 and a contact portion of the rocking member 371 that protrudes from an upper surface of the paper sheet discharge tray 36 are disposed so as to oppose each other.

Also in the present embodiment, the main control portion 8a executes the discharge determination processing also for the paper sheet conveyance device 3A. In other words, the main control portion 8a determines whether the paper sheet 90 is present on the paper sheet discharge tray 36 based on a detection state of the paper sheet detection portion 37 obtained when the blower 38 is operating at the reference output.

In addition, similar to the document sheet conveyance control portion 8d, the paper sheet conveyance control portion 8b executes the fluctuating air-blow control with respect to the blower 38 of the paper sheet conveyance device 3A. In the fluctuating air-blow control with respect to the blower 38, the first period includes a period during which the paper sheet 90 is in midst of being discharged from the discharge port 300a of the paper sheet conveyance path 300.

The paper sheet conveyance control portion 8b determines the first period corresponding to the blower 38 based on the detection result obtained by the passing paper sheet sensor 39.

For example, the paper sheet conveyance control portion 8b determines that a time point at which a predetermined time has elapsed since a time point at which the passing paper sheet sensor 39 has detected the paper sheet 90 is a start point of the first period corresponding to the blower 38.

In addition, the paper sheet conveyance control portion 8b determines that a time point at which a predetermined time has elapsed since a time point at which a change has been made to a state where the paper sheet 90 is no longer detected by the passing paper sheet sensor 39 is an end point of the first period corresponding to the blower 38. For example, the second period is a period from the end point of the first period to a time point at which a predetermined time has elapsed since the end point. The second period may be a period from the end point of the first period to a start point of the next first period.

Further, similar to the document sheet conveyance control portion 8d, the paper sheet conveyance control portion 8b executes the pre-start air-blow control with respect to the blower 38 of the paper sheet conveyance device 3A.

Then, also for the paper sheet conveyance device 3A, the main control portion 8a executes the first failure notification processing that is based on the first failure condition, the second failure notification processing that is based on the second failure condition, and the warning processing that is based on the warning condition, similar to the document sheet conveyance device 5.

Moreover, similar to the document sheet conveyance restriction processing of the document sheet conveyance control portion 8d, the paper sheet conveyance control portion 8b restricts conveyance of the paper sheets 90 corresponding to a new job when the warning condition for the paper sheet conveyance device 3A is established.

The paper sheet conveyance control portion 8b determines that one printing job obtained from the host device via the communication device 85 or one copy job corresponding to the one image reading job is one job related to the paper sheet conveyance device 3A.

Alternatively, the paper sheet conveyance device 3A may include a ventilation duct (not shown) that brings an inlet opening formed on the upper surface of the paper sheet discharge tray 36 and an air supply port of the blower 38 in communication with each other.

Also in the discharge of the paper sheet 90 by the paper sheet conveyance device 3A, effects similar to those obtained in the discharge of the document sheet 9 by the document sheet conveyance device 5 can be obtained.

1. A sheet conveyance device, comprising:
a conveyance mechanism which conveys a sheet along a conveyance path and further discharges the sheet from a discharge port of the conveyance path;
a discharge tray which is disposed below the discharge port on a downstream side of a discharge direction of the sheet and receives the sheet discharged from the discharge port; and
a blower which is disposed above the discharge tray or above the discharge port and blows air downwardly onto the sheet on the discharge tray.

2. The sheet conveyance device according to claim 1, further comprising:
a control portion which executes fluctuating air-blow control for causing the blower to operate at an output lower than a predetermined reference output or causing the blower to stop during a first period including a period in which the sheet is in midst of being discharged from the discharge port, and causing the blower to operate at the reference output during a second period after the first period.

3. The sheet conveyance device according to claim 2, further comprising:
a sheet detection portion which is provided in the discharge tray, includes a displacement portion which is displaced by a weight of the sheet, and detects a displacement of the displacement portion; and
a determination portion which determines whether the sheet is on the discharge tray based on a detection state of the sheet detection portion when the blower is operating at the reference output.

4. The sheet conveyance device according to claim 3, further comprising:
a first notification portion which executes predetermined first failure notification processing in a case where it is determined by the determination portion that the sheet is not present on the discharge tray when conveyance of one or a plurality of the sheets corresponding to one job is ended.

5. The sheet conveyance device according to claim 3, further comprising:
a second notification portion which executes predetermined second failure notification processing in a case where a result of the determination by the determination portion, that is obtained while conveyance of one or a plurality of the sheets corresponding to one job is being executed, satisfies a predetermined failure condition.

6. The sheet conveyance device according to claim 3, further comprising:
a third notification portion which executes predetermined warning notification processing based on a result of the determination by the determination portion, wherein
the control portion executes pre-start air-blow control for causing the blower to operate at the reference output before conveyance of one or a plurality of the sheets corresponding to a new job is started, and
in a case where it is determined by the determination portion that the sheet is present on the discharge tray while the pre-start air-blow control is being executed, the control portion restricts the conveyance of the sheets corresponding to the new job, and the third notification portion executes the warning notification processing.

7. The sheet conveyance device according to claim 1, further comprising:
a ventilation duct which brings an opening formed on an upper surface of the discharge tray and an air supply port of the blower in communication with each other.

8. An image reading device, comprising:
the sheet conveyance device according to claim 1; and
a reading portion which reads an image from a sheet conveyed by the sheet conveyance device and outputs data of the read image.

9. An image forming device, comprising:
the sheet conveyance device according to claim 1; and
a printing portion which forms an image on a sheet conveyed by the sheet conveyance device.
